(19) United States
(12) Patent Application Publication
(10) Pub. No.: US 2006/0238306 A1
(43) Pub. Date: Oct. 26, 2006

(54) Combined RFID reader and RF transceiver

(75) Inventor: Sean T. Loving, Lafayette, CO (US)

Correspondence Address: LATHROP & GAGE LC, 4845 PEARL EAST CIRCLE, SUITE 300, BOULDER, CO, 80301, US

(73) Assignee: Skye Tek, Inc.

(21) Appl. No.: 11/409,463

(22) Filed: Apr. 21, 2006

Related U.S. Application Data
(60) Provisional application No. 60/673,692, filed on Apr. 21, 2005.
(60) Provisional application No. 60/712,957, filed on Aug. 31, 2005.

(51) Int. Cl. H04Q 5/22

(52) U.S. Cl. 340/10.1; 340/572.1

(57) ABSTRACT

An RFID reader for communicating with an RFID tag and with a remote RF transceiver. A single transceiver is employed for communicating with RFID tags and with a remote RF transceiver. A single antenna is coupled to the transceiver. In a first mode, the transceiver communicates with the RFID tags via the antenna, on a first frequency. In a second mode, the transceiver communicates with the remote RF transceiver via the same antenna, on the first frequency or a second frequency.

### RELATED APPLICATIONS

This application claims priority to provisional patent application Ser. No. 60/673,692, filed Apr. 21, 2006 and 60/712,957, filed Aug. 31, 2005. The disclosures of which are incorporated herein by reference.

### BACKGROUND

RFID stands for Radio-Frequency IDentification. An RFID transponder, or ‘tag’, serves a similar purpose as a bar code or a magnetic strip on the back of a credit card; it provides an identifier for a particular object, although, unlike a barcode or magnetic strip, some tags support being written to. An RFID system carries data in these tags, and retrieves data from the tags wirelessly. Data within a tag may provide identification for an item in manufacture, goods in transit, a location, the identity of a vehicle, an animal, or an individual. By including additional data, the ability is provided for supporting applications through item-specific information or instructions available upon reading the tag.

A basic RFID system includes a reader or ‘interrogator’ and a transponder (RFID tag) electronically programmed with unique identifying information. Both the transceiver and transponder have antennas, which respectively emit and receive radio signals to activate the tag, read data from the tag, and write data to it. An antenna is a feature that is present in both readers and tags, and is essential for the communication between the two. An RFID system requires, in addition to tags, a mechanism for reading or interrogating the tags and usually requires some means of communicating RFID data to a host device, e.g., a computer or information management system. Often the antenna is packaged with the transceiver and decoder to become a reader (an ‘interrogator’), which can be configured either as a handheld or a fixed-mount device. The reader emits radio waves in ranges of anywhere from one inch to 100 feet or more, depending upon its power output and the radio frequency used. When an RFID tag passes through the electromagnetic zone (its ‘field’) created by the reader, it detects the reader's activation signal upon which it conveys its stored information data. The reader decodes the data encoded in the tag's integrated circuit and the decoded data is often passed to a device (e.g., a computer) for processing.

The word transponder, derived from TRANSmitter/resPONDER, indicates the function of an RFID tag. A tag responds to a transmitted or communicated request for the data it carries, the communication between the reader and the tag being wireless across the space between the two. The essential components that form an RFID system are one or more tags and a reader or interrogator. The basic components of a transponder are, generally speaking, fabricated as low power integrated circuit suitable for interfacing to an external coil, or utilizing ‘coil-on-chip’ technology, for data transfer and power generation, where the coil acts as a tag antenna matched to the frequency supported.

In operation, RFID tags require power, even though the power levels required for operation are invariably very small (microwatts to milliwatts). RFID tags are categorized as active, passive, or semi-active/semi-passive, the designation being determined by the manner in which a particular device derives its power. Active RFID tags are powered by an internal battery and are typically read/write devices. Passive tags operate without an internal battery source, deriving the power to operate from the field generated by the reader. Passive tags are consequently much lighter than active tags, less expensive, and offer a virtually unlimited operational lifetime. However, a passive tag must be powered without interruption during communication with the reader. Passive tags offer advantages in terms of cost and longevity, as they have an almost infinite lifetime and are generally less expensive than active tags.

FIG. 1 is a diagram of a prior art RFID reader 100. As shown in FIG. 1, reader 100 includes two radio modules, where one radio module 110 provides communication with RFID tags (transponders) 105 and a second radio module 120 provides RF backhaul communication with a transceiver 104. Both radio modules 110/120 are connected to a (reader-enabled) device processor 101, which is coupled with device hardware 110/120/102. The radio modules 110/120 are essentially redundant, in that each module includes an identical or similar radio transceiver 114/124, as well as a radio processor 112/122. Furthermore, each radio module 110/120 requires a separate antenna 131/132.

RFID radio module 110 is shown utilizing a circulator 138 (which can, alternatively, be a directional coupler or a diode detector circuit) to selectively direct the received signal to the receiver 118, allowing the transmitted signal from transmitter 116 to pass through to antenna 131, while blocking the received signal from the output of transmitter 116, and while blocking the transmit signal from the input of the receiver 118. Backhaul RF radio module 120 is shown utilizing a transmit/receive (T/R) switch 139 to direct the received signal either to the receiver 138, or to output the transmitted signal from transmitter 136 to antenna 132. Radio module 120 could alternatively employ a circulator (or equivalent device) 138.

Problem to be Solved

In order to read passive RFID tags, an RFID reader's radio transmitter is required to be turned on while the receiver is receiving. Previously existing RFID readers have accommodated this requirement by the use of directional couplers or the like. However, these previous RFID readers nevertheless employ redundant circuitry, including redundant radio modules, one module for communication with RFID tags and another module for communication with a host computer or server, via a backhaul RF transceiver.

In addition, each of the radio modules employed by previous RFID readers typically uses its own radio processor. Furthermore, each of these radio modules employs a separate antenna, thus necessitating the use of at least two antennas for communication with both a tag and a backhaul transceiver. Elimination of these redundant components is thus desirable, to minimize power consumption, and to reduce the number of components and circuit size, thereby also reducing the cost of the reader.

### SOLUTION TO THE PROBLEM

A system and method are disclosed for providing the capability for an RFID reader to communicate with RFID tags and with a remote RF transceiver. A single transceiver is employed for communicating with both the RFID tags and with the remote RF transceiver. A single antenna is coupled to the transceiver. In a first mode, the transceiver communicates with the RFID tags via the antenna, on a first frequency. In a second mode, the transceiver communicates with the remote RF transceiver via the same antenna, on the same frequency or on a second frequency.

### BRIEF DESCRIPTION OF THE DRAWINGS

FIG. 1 is a diagram of a prior art RFID reader, showing the use of two radios to provide corresponding RF and RFID communication;

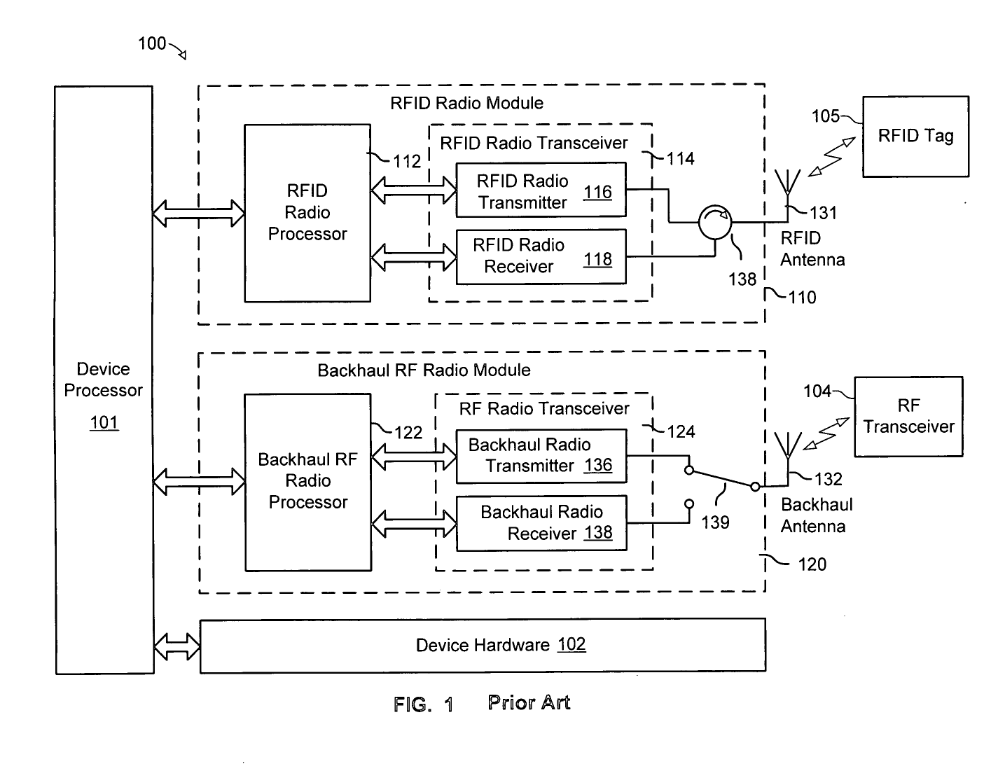

FIG. 2 is a diagram of an exemplary embodiment of the present combined RFID reader and RF transceiver, showing high-level architecture of the system;

FIG. 3 is a diagram of system components in one embodiment of the present system, in which RFID +RF backhaul radio processor code is located in the device processor;

FIG. 4 is a diagram of system components in one embodiment of the present system, in which RFID +RF backhaul radio processor code is located in a combined RFID +RF backhaul radio module;

FIG. 5 is a flowchart showing an exemplary set of steps performed in RF backhaul transmission and receiving, in one embodiment of the present system; and

FIG. 6 is a flowchart showing an exemplary set of steps performed in RFID transmission and receiving, in one embodiment of the present system.

### DETAILED DESCRIPTION

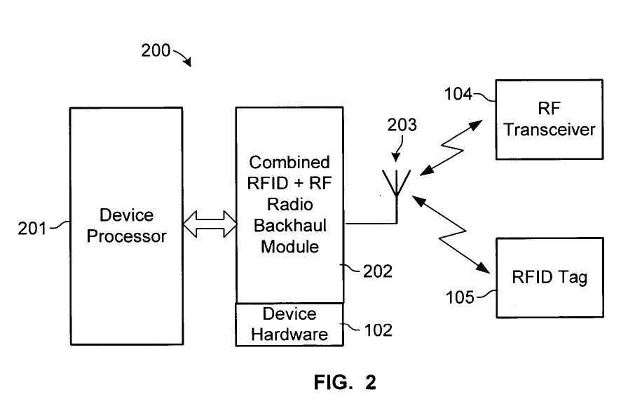

FIG. 2 is a diagram of an exemplary embodiment of the present combined RFID reader and RF transceiver 200, showing high-level architecture of the system. As shown in FIG. 2, the present embodiment comprises a combined RFID and RF backhaul radio transceiver module 202, which is connected to a device processor 201, which typically performs functions specific to the task or application for which the device was designed. Combined RFID+RF radio module 202 uses a single antenna 203 to send signals to, and receive signals from RFID tags 105, as well as for communication with remote RF transceiver 104. Remote transceiver 104 is typically coupled to a host computer or server (not shown), and is used to exchange data between one or more RFID tags and the host computer/server (i.e., backhaul communication). In some cases remote transceiver 104 may be a mobile device such as a wireless sensor network device (i.e., a mote).

In an exemplary embodiment, an IEEE 802.15.4 compliant (‘ZigBee’) radio, operating at approximately 900 MHz is used by the present system to achieve standard ZigBee communication to a host and/or passive UHF RFID communication with EPC (Electronic Product Code) transponders (RFID tags). Alternatively, the present system may employ RF frequencies other than 900 MHz, as well as communication protocols other than IEEE 802.15.4.

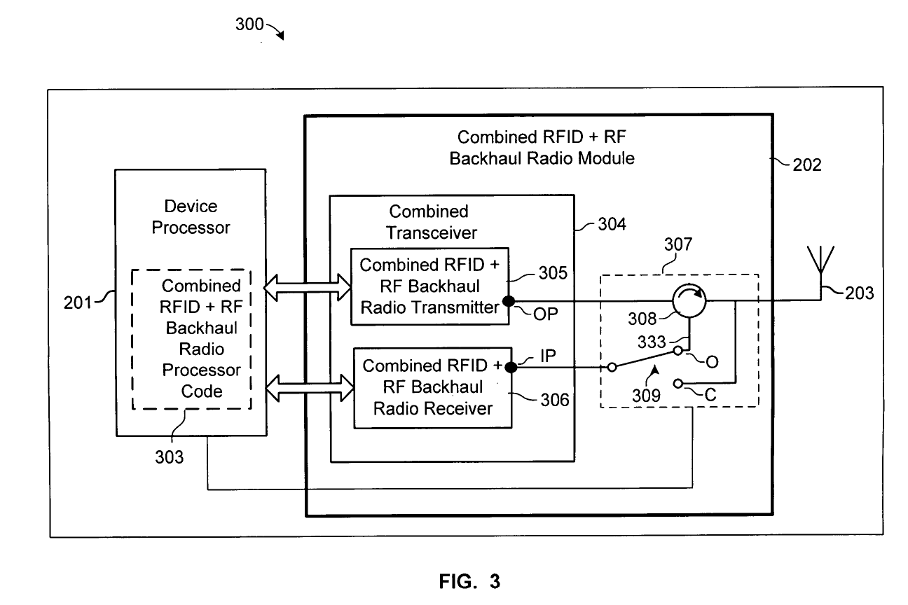

FIG. 3 is a diagram showing system components in one embodiment 300 of the present system. As shown in FIG. 3, in combined RFID reader and RF transceiver 300, combined RFID and RF backhaul radio processor executable code 303 is located in the device processor 201. Combined RFID and RF backhaul radio module 202 includes a combined transceiver 304, comprising a combined RFID and RF backhaul radio transmitter 305, and a combined RFID and RF backhaul radio receiver 306. In one embodiment, communication between the RFID portion of the combined RFID/RF backhaul module 202/402 in systems 200/300/400 and RFID tags 105 takes place at approximately 900 MHz, and communication between modules 202/402 and RF transceiver 104 in systems 200/300/400 occurs at an offset of approximately 2 MHz, e.g., at approximately 902 or 898 MHz.

Radio transmitter 305 and radio receiver 306 are connected to switching device 307, which is connected to combined RF backhaul/RFID antenna 203, and controlled by device processor 201. In an exemplary embodiment, switching device 307 includes a double pole, single throw transmit/receive (‘T/R’) switch 309 and a circulator 308. Circulator 308 is a signal directing (and isolating) device having a junction of three ports in which the ports can be accessed in such an order that when a signal is fed into any port it is transferred to the next port.

In RFID communication mode, switch 309 is set to the closed (‘C’) position, and circulator 308 allows the signal from the output OP of transmitter 305 to flow to antenna 203, while allowing the signal from the antenna to flow through switch 309 to the input IP of receiver 306, while effectively blocking the signal from the antenna from reaching the transmitter output and effectively blocking the output signal from the transmitter 305 from reaching the receiver 306 input.

The function provided by circulator 308 may, alternatively, be provided by other signal directing devices including a directional coupler, a diode detector, a mixer, or the like.

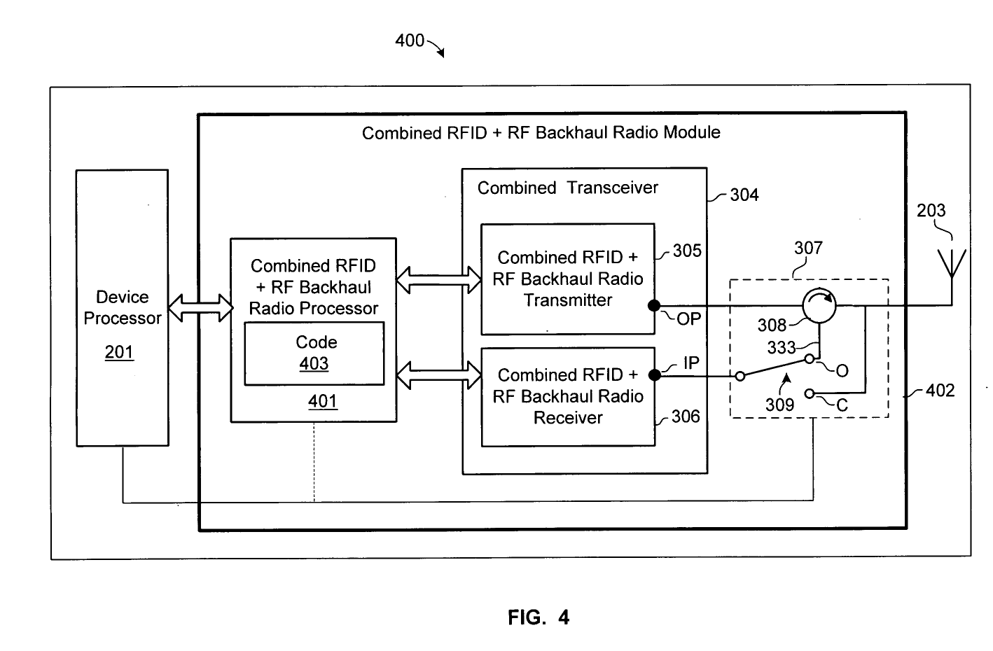

FIG. 4 is a diagram showing system components in one embodiment 400 of the present system. As shown in FIG. 4, combined RFID reader and RF transceiver 400 includes a combined RFID and RF backhaul radio module 402, including a combined RFID and RF backhaul radio processor 401 and associated executable code 403. Radio processor 401 is connected to device processor 201 and to combined transceiver 304, which includes a combined RFID and RF backhaul radio transmitter 305, and a combined RFID and RF backhaul radio receiver 306 as in transceiver 304 described with respect to FIG. 3. Radio processor 401 is controlled by device processor 201, and in turn, controls combined transceiver 304.

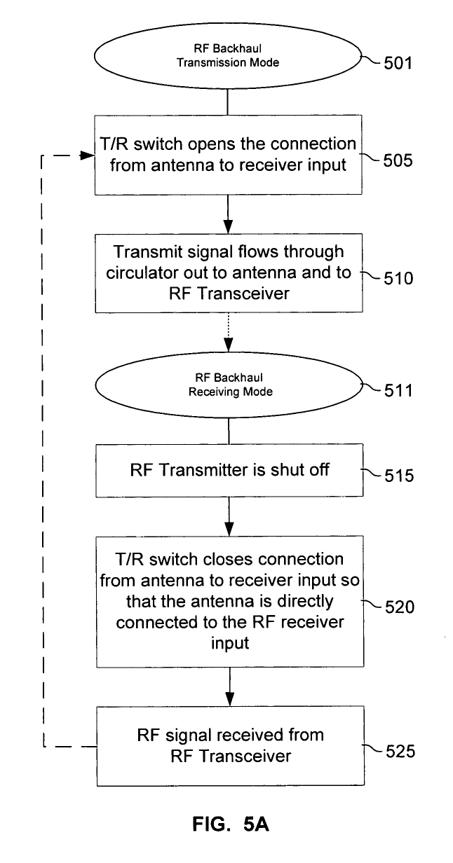

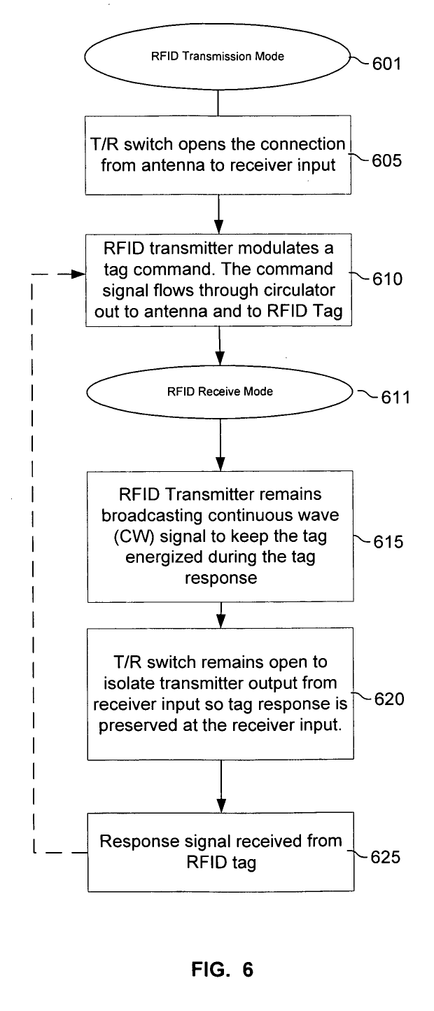

Similarly, with respect to FIG. 3, radio transmitter 305 and radio receiver 306 are connected to switching device 307, which is connected to RFID/RF backhaul antenna 203 and controlled by device processor 201, or alternatively, by radio processor 401. The operation of switching device 307 is described in detail below with respect to FIG. 5 and FIG. 6.

The configuration of the components (e.g., signal directing/isolating device 308 and switch 309) shown in switching device 307 is one of a number of possible component configurations that may be employed to allow the shared use of combined RFID/RF radio backhaul module 202/402 with a single antenna 203. Switching device 307 may alternatively include a directional coupler, a diode detector circuit, a mixer, or the like, to provide the functionality of circulator 308. In an alternative embodiment, switch 309 may be eliminated in switching device 307, in which case input IP of receiver 306 is connected directly to port 333 of device 308, to provide full-duplex operation for RF backhaul mode.

FIG. 5 is a flowchart showing an exemplary set of steps performed in RF backhaul communication between systems 200/300/400 and transceiver 104 (shown in FIG. 2), in one embodiment of the present system. RF backhaul transmission can be divided into two phases or modes, an RF transmission mode 501, and an RF receiving mode 511. Operation of the present system is best understood by viewing FIGS. 3 and 4 in conjunction with FIG. 5.

As shown in FIG. 5, in RF backhaul transmission mode 501, at step 505, T/R switch 309 opens the direct connection from antenna 203 to radio receiver input IP, as indicated by the switch connection to position “O”. This allows the RF backhaul transmit signal to flow through circulator 308 out to antenna 203 and to RF transceiver 104 (shown in FIG. 2), at Step 510.

In RF backhaul receiving mode 511, at step 515, RF transmitter 305 is shut off, and at step 520, T/R switch 309 closes the connection from antenna 203 to receiver input IP, as indicated by the switch connection to position “C”, so that the antenna is directly connected to the RF receiver input. This allows the RF signal to be received from RF Transceiver 104, at step 525.

FIG. 6 is a flowchart showing an exemplary set of steps performed in RFID communication between systems 200/300/400 and RFID tag 105, in one embodiment of the present system. RFID communication can be divided into two phases or modes, an RFID transmission mode 601, and an RFID receiving mode 611. Operation of the present system is best understood by viewing FIGS. 3 and 4 in conjunction with FIG. 6.

As shown in FIG. 6, at step 605, initially, RFID receiver 306 and RFID transmitter 305 are turned on and switch 309 is set to the open (‘O’) position. At step 610, the transmitter 305 modulates the continuous wave (CW) transmit signal (this is the tag command signal). In one example of step 610, device processor software (code 303 in device processor 201 in system 300) or software in radio processor 401 (code 403 in combined RFID/RF backhaul radio processor 401 in system 400) sends control signals to device hardware 102 (shown in FIG. 2) to modulate the CW to send a command to the tag.

At step 615, the CW transmit signal from transmitter 305 flows through circulator 308 and out through antenna 203. At step 620, while transmitter 305 remains on, the T/R switch remains open and circulator 308 blocks the large transmitted signal and passes the signal received from the RFID tag to the input IP of receiver 306. At step 625, the RFID receiver 306 receives the modulated continuous wave (CW) RF signal from RFID tag 105. During communication with RFID tag 105, transmitter 305 remains broadcasting the CW signal to keep the tag energized, as indicated in block 615. At step 625, RFID tag 105 sends its data to the reader 200/300/400 by load modulating the backscattered CW wave that is being transmitted by RFID tag 105.

Certain changes may be made in the above methods and systems without departing from the scope of that which is described herein. It is to be noted that all matter contained in the above description or shown in the accompanying drawings is to be interpreted as illustrative and not in a limiting sense. For example, the methods shown in FIGS. 5 and 6 may include steps other than those shown therein, and the systems shown in FIGS. 2-4 may include different components than those shown in the drawings. The elements and steps shown in the present drawings may be modified in accordance with the methods described herein, and the steps shown therein may be sequenced in other configurations without departing from the spirit of the system thus described. The following claims are intended to cover all generic and specific features described herein, as well as all statements of the scope of the present method, system and structure, which, as a matter of language, might be said to fall there between.

What is claimed is:

1. An RFID reader comprising:
a single transceiver for communicating with an RFID tag and with a remote RF transceiver; and
a single antenna coupled to the transceiver;
wherein, in a first mode, the transceiver communicates with the RFID tags via the antenna on a first frequency; and
wherein, in a second mode, the transceiver communicates with the remote RF transceiver via the antenna on the first frequency or a second frequency.

2. The RFID reader of claim 1, including a switching device coupled to an output of the transceiver and to an input of the transceiver;
wherein, in the first mode, the switching device is set to couple the output of a transmitter to the antenna to send signals to the RFID tag, and to couple the input of a receiver to the antenna to receive signals from the RFID tag; and
wherein, in the second mode, the switching device is set to couple the output of the transmitter to the antenna to send signals to the remote RF transceiver, and to couple the input of the receiver to the antenna to receive signals from the remote RF transceiver.

3. The RFID reader of claim 2, wherein the switching device couples the output of the transmitter to the antenna to send outgoing signals, and couples the antenna to the input of the receiver to receive incoming signals;
wherein, in the first mode, the transmitter sends signals to an RFID tag and receives signals therefrom on a first frequency; and
wherein, in the second mode, the transmitter sends signals to the remote RF transceiver and receives signals therefrom on the first frequency or a second frequency.

4. The RFID reader of claim 2, including a device processor, coupled to the switching device for controlling the switching device.

5. The RFID reader of claim 2, wherein the switching device comprises:
a signal directing device having a first port coupled to the transmitter, a second port coupled to the antenna, and a third port coupled to a first pole of a double pole, single throw switch;
wherein the antenna is also coupled to a second pole of the switch, and the receiver is coupled to a switching element of the switch which is selectively connected to either the first pole of the switch for sending signals to and receiving signals from the RFID tag, or connected to the second pole of the switch for sending signals to and receiving signals from the remote RF transceiver.

6. The RFID reader of claim 5, wherein the signal directing device includes a device selected from the group of devices consisting of a directional coupler, a diode detector circuit, a mixer, and a circulator.

7. The RFID reader of claim 5, including a device processor, coupled to the signal directing device for controlling the signal directing device.

8. The RFID reader of claim 7, wherein the device processor includes a combined RFID and RF backhaul radio processor for controlling the transceiver, wherein the radio processor is controlled by the device processor.

9. The RFID reader of claim 7, including a combined RFID and RF backhaul radio processor controlled by the device processor, including code for controlling the transceiver.

10. The RFID reader of claim 9, wherein the radio processor controls the signal directing device.

11. An RFID reader comprising:
a combined RFID reader and backhaul transceiver including a single receiver and a single transmitter;
a switching device coupled to an output of the transceiver and to an input of the transceiver; and
a single antenna coupled to the switching device;
wherein, in a first mode, the switching device is set to couple an output of the transmitter to the antenna to send signals to an RFID tag, and to couple an input of the receiver to the antenna to receive signals from the RFID tag; and
wherein, in a second mode, the switching device is set to couple the output of the transmitter to the antenna to send signals to a remote RF transceiver, and to couple the input of the receiver to the antenna to receive signals from the remote RF transceiver.

12. The RFID reader of claim 11, wherein signals are sent and received in the first mode on a first frequency, and signals are sent and received in the second mode on the first frequency or a second frequency.

13. The RFID reader of claim 11, wherein the switching device comprises:
a signal directing device having a first port coupled to the transmitter, a second port coupled to the antenna, and a third port coupled to a first pole of a double pole, single throw switch;
wherein the antenna is also coupled to a second pole of the switch, and the receiver is coupled to a switching element of the switch which is selectively connected to either the first pole of the switch for sending signals to and receiving signals from the RFID tag, or connected to the second pole of the switch for sending signals to and receiving signals from the remote RF transceiver.

14. The RFID reader of claim 13, including a device processor, coupled to the signal directing device for controlling the signal directing device.

15. The RFID reader of claim 11, including a device processor, coupled to the switching device for controlling the switching device.

16. The RFID reader of claim 11, wherein the remote transceiver is coupled to a host computer to exchange data between one or more RFID tags and the host computer.

17. The RFID reader of claim 11, wherein a signal directing device includes a device selected from the group of devices consisting of a directional coupler, a diode detector circuit, a mixer, and a circulator.

18. The RFID reader of claim 11, including a device processor coupled to a signal directing device for controlling the signal directing device.

19. The RFID reader of claim 18, wherein the device processor includes a combined RFID and RF backhaul radio processor for controlling the transceiver, wherein the radio processor is controlled by the device processor.

20. The RFID reader of claim 18, including a combined RFID and RF backhaul radio processor controlled by the device processor, including code for controlling the transceiver.

21. The RFID reader of claim 20, wherein the radio processor controls the signal directing device.

22. An RFID reader comprising:
a combined RFID reader and backhaul transceiver including a single receiver and a single transmitter;
a switching device coupled to an output of the transceiver and to an input of the transceiver; and
a single antenna coupled to the switching device;
wherein, the switching device couples an output of the transmitter to the antenna to send outgoing signals, and couples the antenna to an input of the receiver to receive incoming signals;
wherein, in a first mode, the transmitter sends signals to an RFID tag and receives signals therefrom on a first frequency; and
wherein, in a second mode, the transmitter sends signals to a remote RF transceiver and receives signals therefrom on the first frequency or a second frequency.

23. An RFID reader comprising:
a combined RFID reader and backhaul transceiver including a single receiver and a single transmitter;
switching means for coupling an output of the transmitter to an antenna for sending outgoing signals, and for coupling the antenna to an input of the receiver to receive incoming signals;
the antenna coupled to the switching means;
wherein, in a first mode, the transmitter sends signals to an RFID tag and receives signals therefrom on a first frequency; and
wherein, in a second mode, the transmitter sends signals to a remote RF transceiver and receives signals therefrom on the first frequency or a second frequency.

24. An RFID reader comprising:
a combined RFID reader and backhaul transceiver including a single receiver and a single transmitter;
a switching device coupled to an output of the transceiver and to an input of the transceiver;
a combined RFID and RF backhaul radio processor coupled to the combined RFID reader and backhaul transceiver, and also coupled to a device processor for controlling the transceiver; and
a single antenna coupled to the switching device;
wherein, in a first mode, the switching device is set to couple an output of the transmitter to the antenna to send signals to an RFID tag, and to couple an input of the receiver to the antenna to receive signals from the RFID tag; and
wherein, in a second mode, the switching device is set to couple the output of the transmitter to the antenna to send signals to a remote RF transceiver, and to couple the input of the receiver to the antenna to receive signals from the remote RF transceiver.

25. A method for combining an RFID reader and an RF backhaul transceiver comprising:
controlling a single transceiver to alternatively:
(a) communicate with one or more RFID tags on a first frequency via a single antenna, and
(b) communicate with a remote RF transceiver on the first frequency or a second frequency via the single antenna.

26. The method of claim 25, wherein the single transceiver controls communication with the RFID tags and with the remote RF transceiver by switching means for coupling an output of a transmitter to the antenna for sending outgoing signals, and for coupling the antenna to an input of a receiver to receive incoming signals.

27. The method of claim 25, wherein the single transceiver is controlled by a device processor which controls the communication with the RFID tags and with the remote RF transceiver.

28. The method of claim 25, wherein the single transceiver is controlled by a single radio processor which controls the communication with the RFID tags and with the remote RF transceiver.

29. The method of claim 25, wherein a switching means is controlled by a single radio processor which controls the communication with the RFID tags and with the remote RF transceiver.

30. The method of claim 25, wherein a switching means is controlled by a device processor which controls the communication with the RFID tags and with the remote RF transceiver.

31. A method for combining an RFID reader and an RF backhaul transceiver comprising:
controlling a single transceiver to alternatively:
(a) communicate with one or more RFID tags on a first frequency via a single antenna, and
(b) communicate with a remote RF transceiver on the first frequency or a second frequency via the single antenna;
wherein the single transceiver is controlled using a switching device which performs the additional steps of:
coupling the antenna to a first pole of a double pole, single throw switch, and
coupling a receiver to a switching element of the switch which is selectively connected to either a second pole of the switch for sending signals to and receiving signals from the RFID tag, or connected to the first pole of the switch for sending signals to and receiving signals from the remote RF transceiver;
wherein the switching device comprises the double pole single throw switch and a signal directing device having a first port coupled to a transmitter, a second port coupled to the antenna, and a third port coupled to the first pole of the switch.

32. The method of claim 31, wherein the signal directing device includes a device selected from the group of devices consisting of a directional coupler, a diode detector circuit, a mixer, and a circulator.

33. The method of claim 31, wherein the single transceiver is controlled by a device processor which controls the communication with the RFID tags and with the remote RF transceiver.

34. The method of claim 31, wherein the single transceiver is controlled by a single radio processor which controls the communication with the RFID tags and with the remote RF transceiver.

35. The method of claim 31, wherein the switching device is controlled by a single radio processor which controls the communication with the RFID tags and with the remote RF transceiver.

36. The method of claim 31, wherein the switching device is controlled by a device processor which controls the communication with the RFID tags and with the remote RF transceiver.
